(19) United States
(12) Patent Application Publication
(10) Pub. No.: US 2025/0036089 A1
(43) Pub. Date: Jan. 30, 2025

(54) ACCELERATING SEARCH FOR MULTI-VARIATE CORRELATIONS FOR INDUSTRIAL PROCESS CONTROL

(71) Applicant: Tignis, Inc., Seattle, WA (US)

(72) Inventor: Charles Lincoln Parker, Lake Bluff, IL (US)

(73) Assignee: Tignis, Inc., Seattle, WA (US)

(21) Appl. No.: 18/782,507

(22) Filed: Jul. 24, 2024

Related U.S. Application Data
(60) Provisional application No. 63/515,298, filed on Jul. 24, 2023.

(51) Int. Cl. G05B 13/02

(52) U.S. Cl. CPC G05B 13/021

(57) ABSTRACT

In some embodiments, a computer-implemented method of improving industrial process control by finding significant multi-variate correlations within a plurality of variables representing sensor data is provided. A computing system obtains time series data streams for the plurality of variables. The computing system generates pairwise correlation values between the variables of the plurality of variables. The computing system determines a variable of interest from the plurality of variables, and performs a graph search to determine one or more significant multi-variate correlations between variables from the plurality of variables and the variable of interest. Variables are filtered from the graph search using a heuristic based on the pairwise correlation values. The multi-variate correlations are provided to support the industrial process control.

### CROSS-REFERENCE TO RELATED APPLICATION

This application claims the benefit of Provisional Application No. 63/515,298, filed Jul. 24, 2023, the entire disclosure of which is hereby incorporated by reference herein for all purposes.

### TECHNICAL FIELD

This application relates generally to industrial process control, and in particular but not exclusively, relates to controlling semiconductor manufacturing processes.

### BACKGROUND

In semiconductor manufacturing, the continued advancement of devices has become a foundation of our technology-centric modern world. As node sizes continue to shrink to below what was previously thought imaginable, increasing demands are placed on the size of the acceptable output space for each process step in the semiconductor manufacturing process. Any step output parameter, including but not limited to thin film thickness, feature critical dimension size, or overlay magnitude, is increasingly subject to a tighter tolerance on the precise metric. Thus, when specific wafers or devices fail to meet these tight metrics, increased costs are realized due to higher scrap and rework rates, as well as a longer time to get a new process step in acceptable control to begin high volume production.

In order to reduce the amount of scrap and rework rates, and to otherwise increase the quality of the output, industrial processes (including but not limited to semiconductor manufacturing processes) are monitored using a large number of sensors. The sensors may monitor configuration aspects of industrial machinery, characteristics of input materials, characteristics of output products, environmental conditions, or any other relevant state. Often, thousands of sensors may generate data streams such as time-series data streams during the industrial process. Since the number of variables to be monitored is very large, it is impractical to review all of the sensor data while controlling the industrial process (e.g., when performing a root cause analysis, to improve efficiency or quality, etc.). Accordingly, it is often desirable to find correlations between two or more of the data streams.

Finding univariate correlations in even large datasets is a commonly addressed problem. Traditional statistical methods including the Pearson correlation, the Spearman rank correlation, and/or others are fast and efficient, running fractions of a second on nearly any data large enough to fit in memory. Modern statistical techniques such as the distance correlation and the total information criterion eliminate restrictive assumptions and will detect any relationship, even nonfunctional ones, from given pairs of time series data streams. Even if there are many thousands of variables, estimating all univariate correlations between all pairs of variables is still often computationally feasible, especially if one is able to throw large amounts of computing resources at the problem.

This efficiency begins to breakdown, however, when attempting to find significant multivariate correlations in a dataset. Even when the analysis is limited to a single variable of interest (call this variable the “target”, t), finding all two-variable and three-variable correlations to t results in “n choose 2” and “n choose 3” correlation computations (where n is the number of variables in the dataset), a number that becomes quickly intractable as the width of the dataset grows.

What is desired are techniques that provide the ability to efficiently search even large numbers of time series data streams for significant multi-variate correlations of a variety of widths.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method of improving industrial process control by finding significant multi-variate correlations within a plurality of variables representing sensor data is provided. A computing system obtains time series data streams for the plurality of variables. The computing system generates pairwise correlation values between the variables of the plurality of variables. The computing system determines a variable of interest from the plurality of variables, and performs a graph search to determine one or more significant multi-variate correlations between variables from the plurality of variables and the variable of interest. Variables are filtered from the graph search using a heuristic based on the pairwise correlation values. The multi-variate correlations are provided to support the industrial process control.

A non-transitory computer-readable medium having computer-executable instructions stored thereon is provided. The instructions, in response to execution by one or more processors of a computing system, cause the computing system to perform actions for improving industrial process control by finding significant multi-variate correlations within a plurality of variables representing sensor data, the actions comprising: obtaining, by the computing system, time series data streams for the plurality of variables; generating, by the computing system, pairwise correlation values between the variables of the plurality of variables; determining, by the computing system, a variable of interest from the plurality of variables; performing, by the computing system, a graph search to determine one or more significant multi-variate correlations between variables from the plurality of variables and the variable of interest, wherein variables are filtered from the graph search using a heuristic based on the pairwise correlation values; and providing the multi-variate correlations to support the industrial process control.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a high-level schematic illustration of a system in which a correlation discovery computing system is used to find and utilize multi-variate correlations between time series data streams of sensor data collected during a manufacturing process (such as the illustrated semiconductor manufacturing process), according to various aspects of the present disclosure.

FIG. 2 is a block diagram that illustrates aspects of a non-limiting example embodiment of a correlation discovery computing system according to various aspects of the present disclosure.

FIG. 3 is a flowchart that illustrates a non-limiting example embodiment of a method of determining multi-variate correlations to support industrial process control, according to various aspects of the present disclosure.

FIG. 4A-FIG. 4B are a flowchart that illustrates a non-limiting example embodiment of a subroutine for performing a graph search to determine one or more significant multi-variate correlations between variables from a plurality of variables and a variable of interest, according to various aspects of the present disclosure.

FIG. 5 is a flowchart that illustrates a non-limiting example embodiment of a subroutine for calculating a heuristic value for a candidate correlation record based on pairwise correlation values stored in the correlation data store, according to various aspects of the present disclosure.

FIG. 6 is a flowchart that illustrates a non-limiting example embodiment of a subroutine for evaluating a selected candidate correlation record using an expansion criterion, according to various aspects of the present disclosure.

FIG. 7A-FIG. 7F are a schematic illustration of certain aspects of a non-limiting example embodiment of the graph search technique illustrated in FIG. 4A-FIG. 4B.

### DETAILED DESCRIPTION

The present disclosure provides techniques for efficiently finding multi-variate correlations of arbitrary widths within data sets having large numbers of variables, such as data sets generated during complex manufacturing processes such as semiconductor manufacturing processes. By approaching the search for significant multi-variate correlations as a graph search problem in which significant multi-variate correlations are represented as high-value nodes in the graph, solutions to this otherwise intractable problem can be efficiently found, and these multi-variate correlations can then be used to improve the output of the manufacturing processes themselves.

Conceptually, embodiments of the present disclosure search a graph in which each node represents a subset of the variables in the data set. Visiting a node in the graph search constitutes computing a multi-variate correlation between the variables of the node and a target variable. There is no specific single “goal” node in the graph, but instead, embodiments of the present disclosure may begin at any single-variable node (a target variable node) and visit as many high-correlation nodes within the graph reachable from the single-variable node as possible, identifying the highest correlation nodes found to be used to analyze and/or adjust the manufacturing process.

As computing multi-variate correlations can be a computationally expensive task (particularly as the width of the multi-variate correlations begins to increase), embodiments of the present disclosure use various techniques to reduce the number of multi-variate correlations computed while still efficiently finding significant correlations within the graph, as discussed in further detail below.

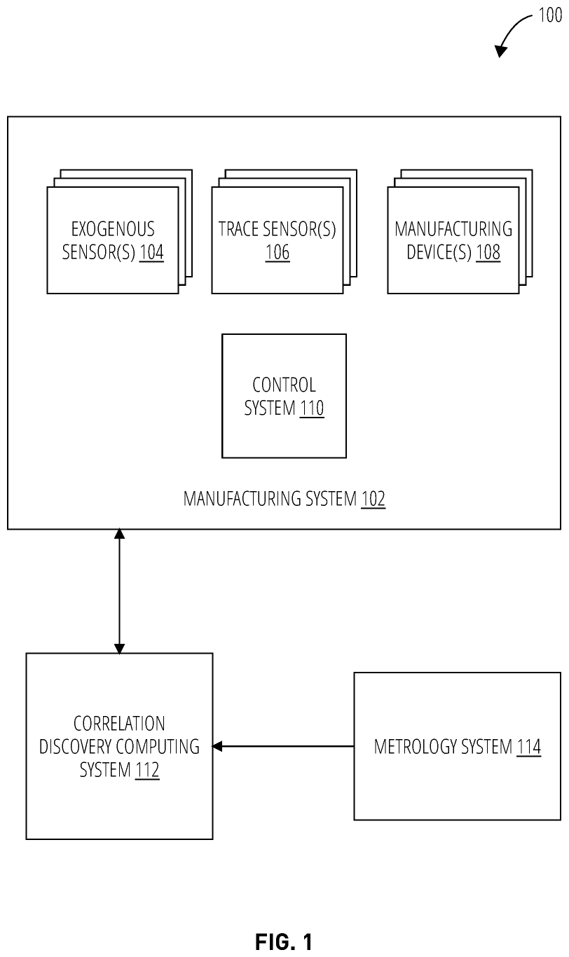

FIG. 1 is a high-level schematic illustration of a system in which a correlation discovery computing system is used to find and utilize multi-variate correlations between time series data streams of sensor data collected during a manufacturing process (such as the illustrated semiconductor manufacturing process), according to various aspects of the present disclosure. As shown, the system 100 includes a manufacturing system 102, a correlation discovery computing system 112, and a metrology system 114.

In some embodiments, the manufacturing system 102 may be any system or collection of sub-systems that perform a manufacturing process such as a semiconductor manufacturing process. The manufacturing system 102 includes one or more manufacturing devices 108 that perform the physical steps of the manufacturing process, as well as a control system 110 that provides control inputs to the manufacturing devices 108. In a semiconductor manufacturing process, some examples of manufacturing devices 108 may include, but are not limited to, a thin film deposition device, a photolithography device, an etching device, an overlay correction device, and a chemical mechanical planarization device. Some examples of semiconductor manufacturing process steps performed by such devices include, but are not limited to, thin film deposition, photolithography, etching, overlay correction, and chemical mechanical planarization.

During operation of the manufacturing devices 108, one or more exogenous sensors 104 and one or more trace sensors 106 generate data that may be transmitted to and consumed by the correlation discovery computing system 112. In some embodiments, the trace sensors 106 may include one or more sensors that measure characteristics of a manufacturing device 108 or an action performed by a manufacturing device 108. Examples of characteristics measured by trace sensors 106 include, but are not limited to, one or more of heating element zone temperatures; mass flow rates of inlet and/or exhaust gas streams; chamber pressures; power supply currents, voltages, powers, and/or frequencies; or optical emission spectroscopy wavelength bands of exhaust streams. In some embodiments, the exogenous sensors 104 may include one or more sensors that measure characteristics of the environment in which the manufacturing devices 108 are operating that may affect the condition of an output of the manufacturing devices 108 for one reason or another. Examples of characteristics that may be measured by the exogenous sensor 104 include, but are not limited to, one or more of a timestamp of an action taken by a manufacturing device 108, an ambient temperature, or a relative humidity. In some embodiments, apriori values may also be collected and reported by the exogenous sensors 104 and/or the trace sensors 106. Examples of apriori values may include, but are not limited to, one or more of a wafer number, a chamber accumulation counter value, a hot plate identifier, and a measurement value from a previous process step.

Once the manufacturing devices 108 perform one or more steps on an input (e.g., a wafer), the metrology system 114 may measure an output of the manufacturing devices 108 (e.g., an output wafer) to analyze the accuracy of the operations performed by the manufacturing devices 108. The metrology system 114 may generate one or more measured metrology values based on the output, including but not limited to one or more of a thickness, a stress, a refractive index, a sidewall angle, and an etch critical dimension. The measured metrology values may then be used by a process engineer to determine whether a given output is acceptable, or whether there are adjustments that should be made to the manufacturing process to improve the quality of the output.

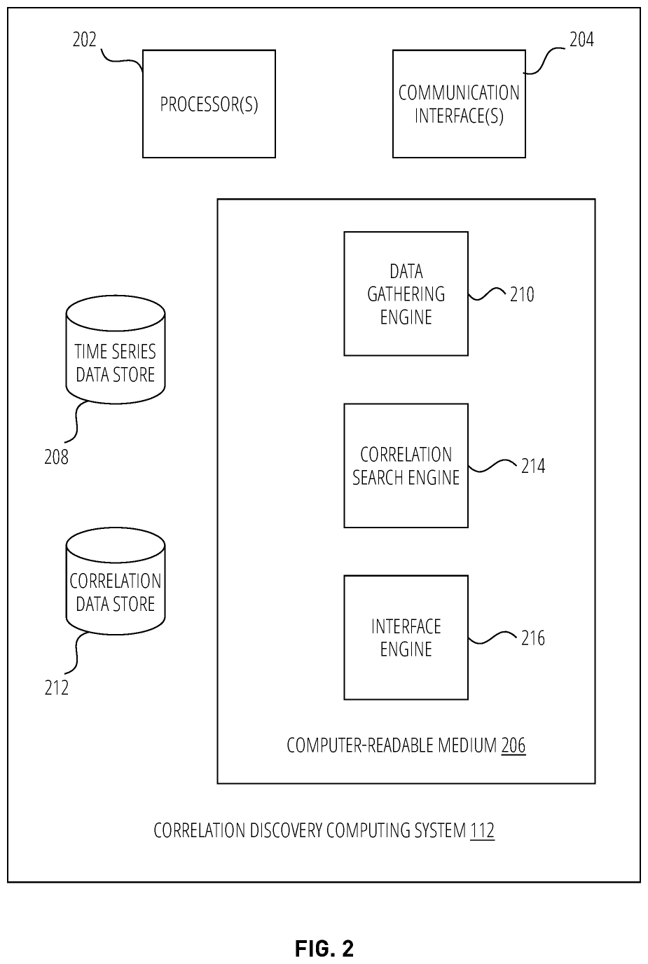

FIG. 2 is a block diagram that illustrates aspects of a non-limiting example embodiment of a correlation discovery computing system according to various aspects of the present disclosure. The illustrated correlation discovery computing system 112 may be implemented by any computing device or collection of computing devices, including but not limited to a desktop computing device, a laptop computing device, a mobile computing device, a server computing device, a computing device of a cloud computing system, and/or combinations thereof. As discussed in general above and in further detail below, the correlation discovery computing system 112 is configured to use graph-based techniques to search for significant multi-variate correlations within datasets having large numbers of time series data streams.

As shown, the correlation discovery computing system 112 includes one or more processors 202, one or more communication interfaces 204, a time series data store 208, a correlation data store 212, and a computer-readable medium 206.

In some embodiments, the processors 202 may include any suitable type of general-purpose computer processor. In some embodiments, the processors 202 may include one or more special-purpose computer processors or AI accelerators optimized for specific computing tasks, including but not limited to graphical processing units (GPUs), vision processing units (VPUs), and tensor processing units (TPUs).

In some embodiments, the communication interfaces 204 include one or more hardware and or software interfaces suitable for providing communication links between components. The communication interfaces 204 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As shown, the computer-readable medium 206 has stored thereon logic that, in response to execution by the one or more processors 202, cause the correlation discovery computing system 112 to provide a data gathering engine 210, a correlation search engine 214, and an interface engine 216.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

In some embodiments, the data gathering engine 210 is configured to receive time series data streams from the trace sensors 106 and/or exogenous sensors 104 of the manufacturing system 102, and to store the time series data streams in the time series data store 208 for further analysis. In some embodiments, the correlation search engine 214 is configured to search the time series data streams for significant multi-variate correlations using graph-based techniques, and to store significant multi-variate correlations that are found within the correlation data store 212. In some embodiments, the interface engine 216 is configured to select multi-variate correlations stored in the correlation data store 212 to be presented to a user or otherwise used to support improvements in the process executed by the manufacturing system 102.

Further description of the configuration of each of these components is provided below.

As used herein, “engine” refers to logic embodied in hardware or software instructions, which can be written in one or more programming languages, including but not limited to C, C++, C#, COBOL, JAVA™, PHP, Perl, HTML, CSS, Javascript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

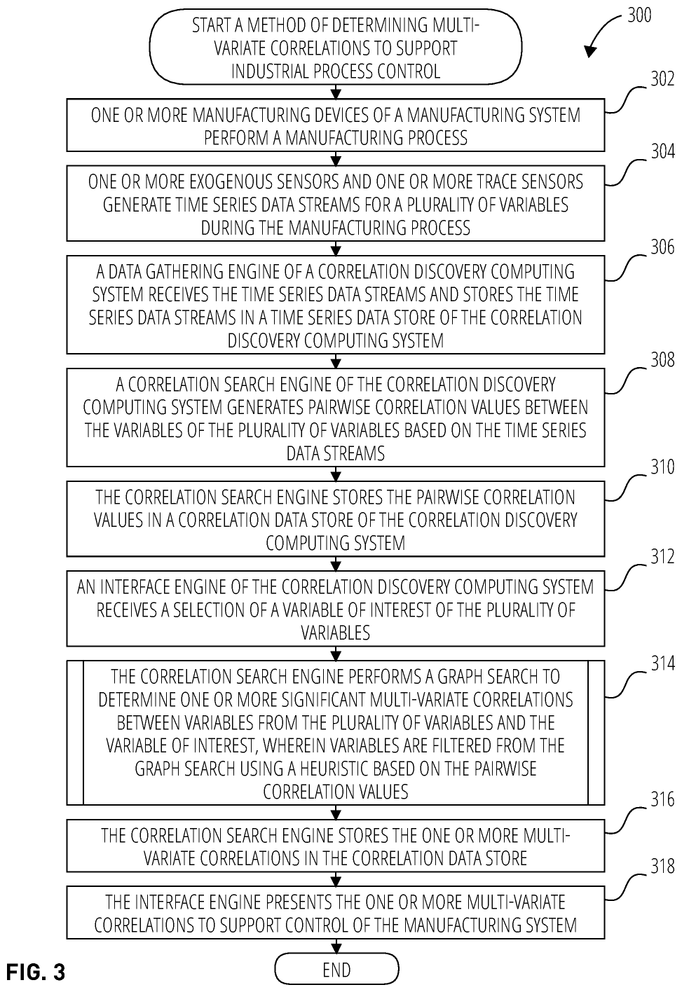

FIG. 3 is a flowchart that illustrates a non-limiting example embodiment of a method of determining multi-variate correlations to support industrial process control, according to various aspects of the present disclosure.

As mentioned above, the method 300 conceptualizes the search for significant multi-variate correlations between time series data streams as a graph search. In the graph, nodes represent combinations of variables. There are nodes for all possible subsets of variables in the graph, which may be limited to subsets of size k (which is a user-defined threshold that represents a breadth vs depth tradeoff). For example, for a dataset having variables named A, B, and C to be correlated with a target variable D, embodiments of the present disclosure will conceptually process a graph for each subset in the power set of the three variables (e.g., {{A}, {B}, {C}, {AB}, {AC}, {BC}, {ABC}}) to be correlated with the target variable D. The nodes of the graph are connected by directed edges if a node can be transformed into another node by adding a single variable to the set. Extending the above example, the node {A} would have an edge to the node {AB}, because the node {A} is transformed into the node {AB} by adding the variable B. Conversely, there is no node connecting the node {AB} to the node {BC}.

In some embodiments, the nodes of the graph may represent combinations of variables to be correlated with a target variable. In some embodiments, nodes of the graph may include the target variable. At points in the discussion herein, such embodiments may be described interchangeably, and those of ordinary skill in the art will recognize that the operations performed in these embodiments may differ in minor ways, such as by using a root node of the graph that either includes or does not include the target variable.

While conceptualizing the search for significant multi-variate correlations as a graph search helps organize approaches to the problem, not all graph search algorithms will address the problems of intractability involved when the number of time series data streams increases. In order to improve the efficiency of the techniques in order to overcome the technical problems involved in the intractable nature of searching for multi-variate correlations in large numbers of time series data streams, embodiments of the present disclosure use carefully selected and designed graph search techniques. In some embodiments, a greedy search may be performed, in which locally optimal choices for which edges of the graph to follow are made in order to approach optimal solutions.

One non-limiting example of a suitable search technique to be used is a modified beam search technique. In such a technique, at any given point in the search of the graph, there is a set of nodes that could be visited (i.e., nodes for which a multi-variate correlation for their constituent variables could be calculated) from nodes that have already been visited (i.e., nodes for which a multi-variate correlation for their constituent variables is already known). The list of adjacent nodes that could be visited is the “beam,” which is also referred to herein as a “candidate correlation set,” with each node also being referred to herein as a “candidate correlation record.”

To choose which nodes to visit, a heuristic function is calculated for each of the visited nodes, which may be used to sort the visited nodes based on how likely they are to represent a portion of the graph having a high-value node. By using a heuristic function designed to be computed more efficiently than computing the actual multi-variate correlation between the variables of the node, a massive increase in computing speed is obtained, and fewer computing resources are used to search the graph. This helps make the otherwise intractable search problem solvable in reasonable time for supporting improvements in the manufacturing process. In some embodiments, the performance is further improved by intelligently choosing which visited nodes should be expanded (i.e., which portions of the graph should be searched), and which visited nodes may be excluded from further processing due to being unlikely to have child nodes that represent better multi-variate correlations than the respective visited nodes.

From a start block, the method 300 proceeds to block 302, where one or more manufacturing devices 108 of a manufacturing system 102 perform a manufacturing process. In some embodiments, the manufacturing process is a semiconductor manufacturing process that includes one or more of deposition, removal, patterning (e.g., photolithography, etc.), doping, and/or other semiconductor processing actions applied to a silicon wafer. In some embodiments, a different manufacturing process may be performed. At block 304, one or more exogenous sensors 104 and one or more trace sensors 106 generate time series data streams for a plurality of variables during the manufacturing process. Each time series data stream represents values of a single variable over time. For example, an exogenous sensor 104 that generates readings of an ambient temperature surrounding a specific manufacturing device 108 may generate a time series data stream representing values for an “ambient temperature” variable over time.

At block 306, a data gathering engine 210 of a correlation discovery computing system 112 receives the time series data streams and stores the time series data streams in a time series data store 208 of the correlation discovery computing system 112. In some embodiments, one or more of the time series data streams may be formatted to include a series of timestamp-value pairs indicating the value of the variable at the given timestamps. In some embodiments, one or more of the time series data streams may include instantaneous values of the variable over time, and timestamps may be added by the data gathering engine 210 upon receiving the values prior to storage in the time series data store 208. In some embodiments, one or more of the time series data streams may include values of the variable over time at a given frequency, and the data gathering engine 210 may determine timestamps or otherwise align such time series data streams with other time series data streams with reference to the given frequency and a start time of the manufacturing process.

At block 308, a correlation search engine 214 of the correlation discovery computing system 112 generates pairwise correlation values between the variables of the plurality of variables based on the time series data streams, and at block 310, the correlation search engine 214 stores the pairwise correlation values in a correlation data store 212 of the correlation discovery computing system 112. Any suitable technique may be used to generate the pairwise correlation values, including but not limited to Pearson correlation techniques, Spearman rank correlation techniques, distance correlation techniques, and/or total information criterion techniques. Even with large numbers of variables, these techniques may be used to quickly determine pairwise correlation values between the variables without consuming an undue amount of computing resources, and this efficient pre-computation of all pairwise correlation values between the variables will provide additional efficiencies later within the method 300.

At block 312, an interface engine 216 of the correlation discovery computing system 112 receives a selection of a variable of interest of the plurality of variables. In some embodiments, the interface engine 216 may present a list of variables to a user, and may receive a selection from the user of a variable from the presented list of variables.

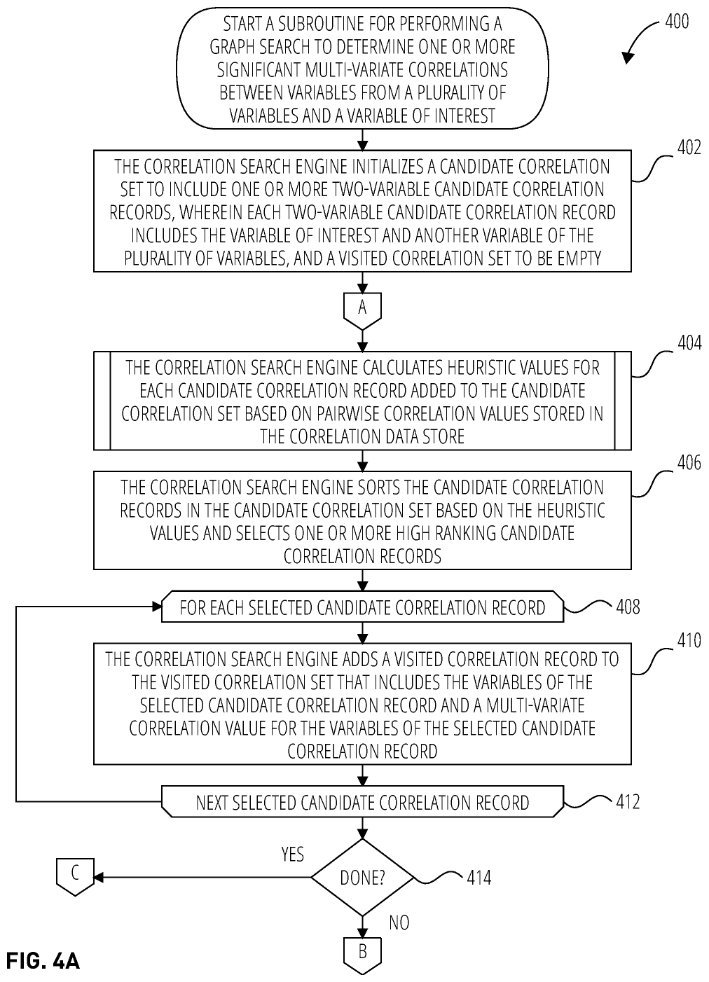

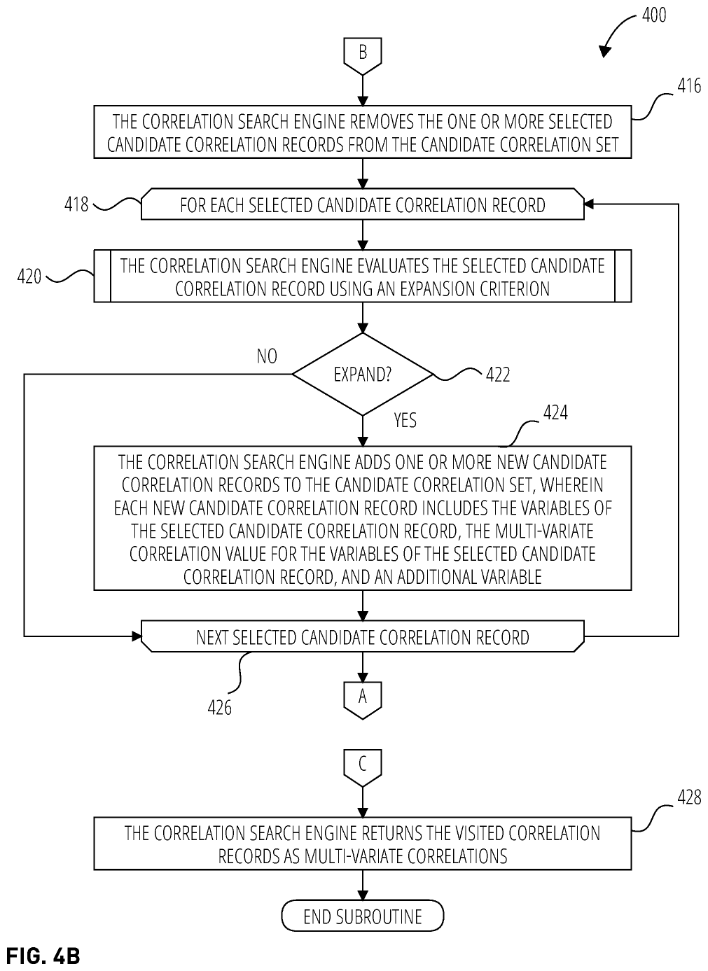

At subroutine block 314, a subroutine is executed wherein the correlation search engine 214 performs a graph search to determine one or more multi-variate correlations between variables from the plurality of variables and the variable of interest, wherein variables are filtered from the graph search using a heuristic based on the pairwise correlation values. As stated above, the selection/development of an appropriate heuristic helps provide the computing efficiencies that make the method 300 able to process large graphs. By pre-computing the pairwise correlation values at block 308, these values are available for use by the heuristic without incurring further computing costs. Any suitable subroutine may be used to perform the graph search using the heuristic, including but not limited to the subroutine 400 illustrated in FIG. 4A-FIG. 4B and described in further detail below.

At block 316, the correlation search engine 214 stores the one or more multi-variate correlations in the correlation data store 212, and at block 318, the interface engine 216 presents the one or more multi-variate correlations to support control of the manufacturing system 102. The interface engine 216 may present the one or more multi-variate correlations using any suitable format. For example, in some embodiments, the interface engine 216 may sort the multi-variate correlations based on the multi-variate correlation values for the multi-variate correlations, such that the most correlated multi-variate correlations are presented at the top of the sort order. However, this may result in a single highly correlated feature to cause a multi-variate correlation to be highly ranked regardless of the correlation of other constituent variables. Accordingly, in some embodiments, the interface engine 216 may use more complex sorting techniques to allow useful multi-variate correlations to be surfaced.

For example, in some embodiments, the interface engine 216 may sort single variable correlations (i.e., multi-variate correlations that include only a target variable and a single other variable, which may be the pairwise correlation value between the target variable and a single other variable) and multiple variable correlations (i.e., multi-variate correlations that include the target variable and two or more other variables) in separate groups. The single variable correlations may be sorted according to their pairwise correlation values, such that more highly correlated single variable correlations are sorted higher. Instead of being sorted by the multi-variate correlation value, the multi-variate correlations may be sorted according to how much more correlated the group is than each of its constituent members (e.g., by separately comparing the multi-variate correlation value to the pairwise correlation values between the target variable and each of the variables in the group). This sorting of multi-variate correlations provides high rankings to groups of variables in which the particular combination is adding value above the individual parts.

In some embodiments, other sorting techniques may be used to cause important multi-variate correlations to be highly ranked. As a non-limiting example, the interface engine 216 may apply a bias or a penalty toward groups that include multiple features versus groups that include single features. As another non-limiting example, the interface engine 216 may favor groups that include variables not present in other groups, even if a multi-variate correlation value for the group is lower than that for other groups.

Once presented, the multi-variate correlations may be used to help improve the performance of the manufacturing process in any way. In some embodiments, a process engineer may review data generated by the metrology system 114 to identify errors in the output of the manufacturing process, and may use the multi-variate correlations as part of a root-cause analysis to determine configuration changes to be applied to the manufacturing devices 108 for subsequent runs of the manufacturing process. In some embodiments, once a highly relevant multi-variate correlation is determined, the multi-variate correlation may be used as part of an automatic control of a manufacturing device 108. For example, if some settings are required to be held constant while other settings are adjustable, a multi-variate correlation may identify a setting that may be automatically adjusted instead of a correlated fixed setting.

The method 300 then proceeds to an end block and terminates.

FIG. 4A-FIG. 4B are a flowchart that illustrates a non-limiting example embodiment of a subroutine for performing a graph search to determine one or more significant multi-variate correlations between variables from a plurality of variables and a variable of interest, according to various aspects of the present disclosure. In the subroutine 400, a beam search is performed over a graph of nodes as described above, using a heuristic based on the precomputed pairwise correlation values for the variables to improve efficiency.

In the discussion of the subroutine 400, each node of the graph is described as a “candidate correlation record,” to indicate that the combination of variables indicated by the node is being considered as a candidate for further processing/deeper search, and the “candidate correlation set” that includes the candidate correlation records is the “beam” of the beam search. The heuristic is used to quickly rank the candidate correlation records and select candidate correlation records for further processing. Further processing includes “visiting” the node of the graph by computing the multi-variate correlation value for the combination of variables in the candidate correlation record and adding the candidate correlation record and multi-variate correlation value to a visited correlation set as a visited correlation record. Further processing may also include “expanding” the node of the graph by adding nodes reachable from the node to the candidate correlation set.

From a start block, the subroutine 400 proceeds to block 402, where the correlation search engine 214 initializes a candidate correlation set to include one or more two-variable candidate correlation records, wherein each two-variable candidate correlation record includes the variable of interest and another variable of the plurality of variables, and a visited correlation set to be empty. In some embodiments, instead of including both the variable of interest and another variable in the initial candidate correlation records, the initial candidate correlation records may include single variables, with the variable of interest being assumed to be included. Since the processing of both embodiments is similar, the initial two-variable candidate correlation records are described herein for the sake of clarity.

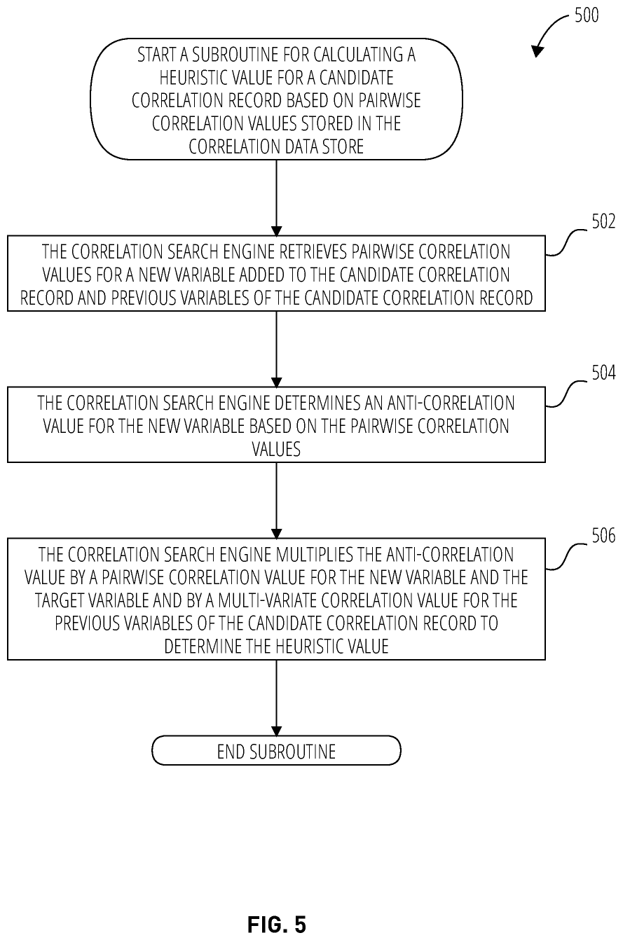

The subroutine 400 then proceeds through a continuation terminal (“terminal A”) to subroutine block 404, where a subroutine is performed wherein the correlation search engine 214 calculates heuristic values for each candidate correlation record added to the candidate correlation set based on pairwise correlation values stored in the correlation data store. The heuristic value is intended to predict whether the multi-variate correlation of the variables in the candidate correlation record is likely to be significant, but by using the pairwise correlation values instead of actually computing the multi-variate correlation value, the heuristic value can be determined using a fraction of the computing resources of the multi-variate correlation. Any suitable subroutine may be used to calculate the heuristic value, including but not limited to the subroutine 500 illustrated in FIG. 5 and discussed in further detail below.

At block 406, the correlation search engine 214 sorts the candidate correlation records in the candidate correlation set based on the heuristic values and selects one or more high ranking candidate correlation records. In some embodiments, a predetermined number of the highest-ranking candidate correlation records (per the heuristic value sorting) may be chosen. In some embodiments, the predetermined number may be determined as a percentage of the number of candidate correlation records within the candidate correlation set, or as a percentage of the number of variables. In some embodiments, the predetermined number may be chosen based on the computing resources available and a desired time for completing the subroutine 400, as the processing of the selected one or more high ranking candidate correlation records will take longer when the predetermined number is higher, and it would be desirable to adjust the predetermined number so that a desired number of iterations/search depth can be reached within the desired time. In some embodiments, the predetermined number may be configurable by the user. In a non-limiting example embodiment, it had been determined that a predetermined number in the thousands was appropriate for achieving an adequate search within tens of seconds.

The subroutine 400 then proceeds to a for-loop defined between a for-loop start block 408 and a for-loop end block 412, wherein each of the selected candidate correlation records is processed. From the for-loop start block 408, the subroutine 400 advances to block 410, where the correlation search engine 214 adds a visited correlation record to the visited correlation set that includes the variables of the selected candidate correlation record and a multi-variate correlation value for the variables of the selected candidate correlation record. In an initial iteration of the beam search in which the variables of the selected candidate correlation records are merely the variable of interest and one additional variable, the multi-variate correlation value may be the pairwise correlation value that was previously determined. In later iterations of the beam search in which the selected candidate correlation records include the variable of interest and two or more other variables, the multi-variate correlation value may be computed by the correlation search engine 214. As with the calculation of the pairwise correlation values, the multi-variate correlation value may be determined using any suitable technique, including but not limited to Pearson correlation techniques, Spearman rank correlation techniques, distance correlation techniques, and/or total information criterion techniques. Typically, the same correlation determination technique is used at block 410 as was used to determine the pairwise correlation values.

The subroutine 400 then proceeds to the for-loop end block 412. If further selected candidate correlation records remain to be processed, then the subroutine 400 returns to the for-loop start block 408 to process the next selected candidate correlation record. Otherwise, if all of the selected candidate correlation records have been processed, then the subroutine 400 proceeds from for-loop end block 412 to decision block 414.

At decision block 414, a decision is made based on whether the subroutine 400 is done searching for significant multi-variate correlations. Any suitable technique may be used to determine whether the subroutine 400 is done. As a non-limiting example, in some embodiments the subroutine 400 may execute until a threshold number of visited correlation records have been created (a predetermined number of nodes in the graph have been visited). As another non-limiting example, the subroutine 400 may execute until a user input is received via the interface engine 216 indicating that enough visited correlation records have been created. As yet another non-limiting example, the subroutine 400 may execute until a visited correlation record with a threshold number of variables has been created. As still another non-limiting example, the subroutine 400 may execute until a visited correlation record having at least a threshold multi-variate correlation value has been created.

If the subroutine 400 is not done searching for significant multi-variate correlations, then the result of decision block 414 is NO, and the subroutine 400 proceeds to a continuation terminal (“terminal B”).

From terminal B (FIG. 4B), the subroutine 400 proceeds to block 416. By block 416, the selected candidate correlation records represent nodes that have been visited, and so no longer need be part of the candidate correlation set for further processing (since they have already been processed). Accordingly, at block 416, the correlation search engine 214 removes the one or more selected candidate correlation records from the candidate correlation set.

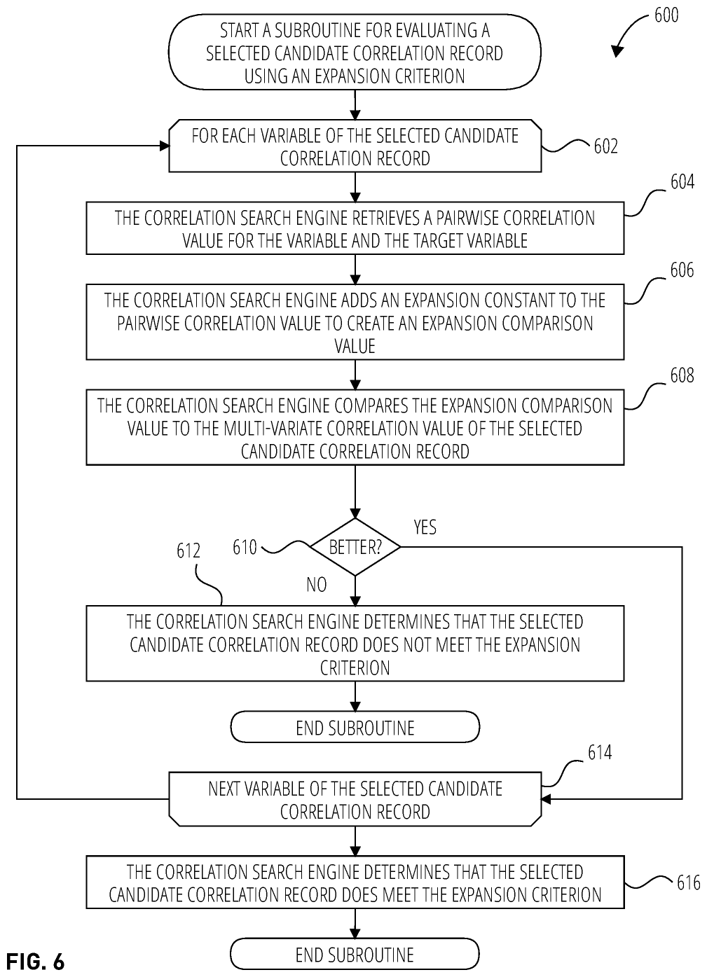

The subroutine 400 then proceeds to a for-loop between a for-loop start block 418 and a for-loop end block 426, wherein each of the selected candidate correlation records is further processed to determine if they should be expanded, and if so, to expand them. From the for-loop start block 418, the subroutine 400 proceeds to subroutine block 420, where a subroutine is performed wherein the correlation search engine 214 evaluates the selected candidate correlation record using an expansion criterion. Any suitable expansion criterion may be used to determine if children of a selected candidate correlation record are likely to include significant multi-variate correlations. One non-limiting example of a suitable expansion criterion is illustrated in FIG. 6 and described in further detail below.

The subroutine 400 then proceeds to a decision block 422, where a decision is made based on whether the expansion criterion indicated that the selected candidate correlation record should be expanded. If the expansion criterion indicated that the selected candidate correlation record should be expanded, then the result of decision block 422 is YES, and the subroutine 400 advances to block 424. If the expansion criterion indicated that the selected candidate correlation record should not be expanded, then the result of decision block 422 is NO, and the subroutine 400 advances directly to the for-loop end block 426.

At block 424, the correlation search engine 214 adds one or more new candidate correlation records to the candidate correlation set, wherein each new candidate correlation record includes the variables of the selected candidate correlation record, the multi-variate correlation value for the variables of the selected candidate correlation record, and an additional variable. In some embodiments, the correlation search engine 214 may add a new candidate correlation record for every variable that is not already part of the selected candidate correlation record, thus representing all nodes of the graph that can be reached from the node represented by the selected candidate correlation record. By including the multi-variate correlation value for the variables already part of the selected candidate correlation record in the new candidate correlation record, this value is available for use by the heuristic function and/or the expansion criterion in subsequent iterations of the beam search. The subroutine 400 then advances to the for-loop end block 426.

At for-loop end block 426, if more selected candidate correlation records remain to be processed, then the subroutine 400 returns to for-loop start block 418 to process the next selected candidate correlation record. Otherwise, if all selected candidate correlation records have been processed, then the subroutine 400 returns to terminal A.

Returning to decision block 414 (FIG. 4A), if the subroutine 400 is done searching for multi-variate correlations, then the result of decision block 414 is YES, and the subroutine 400 proceeds to a continuation terminal (“terminal C”). From terminal C (FIG. 4B), the subroutine 400 advances to block 428, where the correlation search engine 214 returns the visited correlation records as multi-variate correlations. As the visited correlation records include the identities of the considered variables as well as the multi-variate correlation values for the considered variables, the visited correlation records may be used both to identify the variables having significant multi-variate correlations as well as to quantify the significance of the multi-variate correlation between the variables. The subroutine 400 then advances to an end block and returns control to its caller.

FIG. 5 is a flowchart that illustrates a non-limiting example embodiment of a subroutine for calculating a heuristic value for a candidate correlation record based on pairwise correlation values stored in the correlation data store, according to various aspects of the present disclosure. Since there is no one specific goal node within the graph, criteria of admissibility typically used in graph searches need not apply, and many different heuristic functions may be used. That said, it is desirable to use a heuristic that results in exploring nodes that are likely to have high multi-variate correlation values and are likely to be novel in the context of the already visited nodes. The subroutine 500 is a non-limiting example of the use of such a heuristic.

The heuristic of subroutine 500 may be described as follows: The candidate correlation record includes the variable of interest, a set of variables with a known multi-variate correlation value with the variable of interest (which may be referred to as n_{g}), as well as one additional variable v for which the multi-variate correlation value is not yet known. Given a correlation function ƒ_{c}, an approximate correlation between v and n_{g} may be described as:

$${m}_{c} ( v , {n}_{g} ) = max ( {f}_{c} ( v , {n}_{i} ) \vert {n}_{i} ∈ {n}_{g} )$$

Since the correlation value between v and the variable of interest (t) is a previously determined pairwise correlation value, and the correlation between the variable of interest and n_{g} has also been previously determined, the heuristic function ƒₕ may be very efficiently computed:

$${f}_{h} ( t , v , {n}_{g} ) = {f}_{c} ( v , t ) \times {f}_{c} ( {n}_{g} , t ) \times ( 1 - {m}_{c} ( v , {n}_{g} ) )$$

In this formulation, the heuristic value is computed as the product of the pairwise correlation value between the new variable and the variable of interest (which was previously computed), the multi-variate correlation between the variable of interest and the previous variables of the candidate correlation record (which was also previously computed), and an anti-correlation based on the maximum pairwise correlation value for the new variable and the previous variables of the candidate correlation record (each of which had also been previously computed). Stated differently, this heuristic implies that it is desirable to visit a node when a new variable being added to a group is strongly correlated to the variable of interest, when there is a strong multi-variate correlation between the existing variables of the group and the variable of interest, and the new variable is not strongly correlated to any of the existing variables of the group.

The flowchart of FIG. 5 illustrates a non-limiting example embodiment of steps for determining such a heuristic value. From a start block, the subroutine 500 advances to block 502, where the correlation search engine 214 retrieves pairwise correlation values for a new variable added to the candidate correlation record and previous variables of the candidate correlation record, and at block 504, the correlation search engine 214 determines an anti-correlation value for the new variable based on the pairwise correlation values. As described above, the correlation search engine 214 may determine the maximum pairwise correlation value between the new variable and the previous variables of the candidate correlation record, and subtract this maximum value from one to represent the anti-correlation value.

At block 506, the correlation search engine 214 multiplies the anti-correlation value by a pairwise correlation value for the new variable and the target variable and by a multi-variate correlation value for the previous variables of the candidate correlation record to determine the heuristic value. The subroutine 500 then returns control to its caller and provides the heuristic value as a return value.

As stated above, the subroutine 500 is a non-limiting example of the computation of a heuristic value. In some embodiments, other types of computations of heuristic values may be performed instead of or in addition to these computations, including but not limited to computations that prioritize exploration of the graph by introducing a penalty term to new variables that are already in many visited correlation records.

FIG. 6 is a flowchart that illustrates a non-limiting example embodiment of a subroutine for evaluating a selected candidate correlation record using an expansion criterion, according to various aspects of the present disclosure. The heuristic used to select the selected candidate correlation record attempts to predict whether the variables of a candidate correlation record will be highly correlated, and therefore may not always be accurate. That is, the heuristic may sometimes suggest that nodes be visited that include groups of variables that are not in fact highly correlated to the variable of interest. Accordingly, it may be desirable to avoid exploring the nodes adjacent to such nodes, which may be accomplished using the expansion criterion.

The subroutine 600 describes a non-limiting example embodiment of an expansion criterion wherein a selected candidate correlation record fails the expansion criterion if the correlation of the group of variables is not significantly better than the correlations of its constituent variables. Stated another way, the expansion criterion of the subroutine 600 provides a success value upon determining:

$$∀ {n}_{i} ∈ {n}_{g} : {f}_{c} ( {n}_{g} , t ) > {f}_{c} ( {n}_{i} , t ) + ε$$

wherein & is a constant indicating how much better the multi-variate correlation of the group of variables and the variable of interest should be than the pairwise correlations of each constituent variable to the variable of interest in order to warrant expansion. In some embodiments, appropriate values for the constant & may be dependent on the correlation measure and/or the data within the variables. For example, for correlation measures that vary smoothly between 0 and 1, a value for & between 0.01 and 0.05 may be appropriate. As another example, in domains where many variables are highly correlated to an output variable (e.g., many variables have a pairwise correlation value with the variable of interest greater than 0.95), a lower number (including but not limited to numbers in a range of 0.0005 to 0.0015, such as 0.001) may be appropriate. In some embodiments, the value for the constant & may be provided as a user-configurable value.

The flowchart of FIG. 6 illustrates a non-limiting example embodiment of steps for evaluating a selected candidate correlation record using such an expansion criterion. From a start block, the subroutine 600 proceeds to a for-loop defined between a for-loop start block 602 and a for-loop end block 614, wherein each variable of the selected candidate correlation record is processed to determine if the variable causes the selected candidate correlation record to fail the expansion criterion.

From the for-loop start block 602, the subroutine 600 proceeds to block 604, where the correlation search engine 214 retrieves a pairwise correlation value for the variable and the target variable (ƒ_{c}(nᵢ,t). At block 606, the correlation search engine 214 adds an expansion constant (ε) to the pairwise correlation value to create an expansion comparison value (ƒ_{c}(nᵢ,t)+ε).

At block 608, the correlation search engine 214 compares the expansion comparison value to the multi-variate correlation value of the selected candidate correlation record. For example, the correlation search engine 214 may determine whether the multi-variate correlation value (ƒ_{c}(n_{g}, t)) of the selected candidate correlation record is greater than the expansion comparison value, with the multi-variate correlation value being better if it is greater than the expansion comparison value.

If the multi-variate correlation value is better than the expansion comparison value, then the result of decision block 610 is YES, and the subroutine 600 advances to for-loop end block 614, indicating that the variable did not indicate that the expansion criterion should be failed. Otherwise, if the multi-variate correlation value is not better than the expansion comparison value, then the result of decision block 610 is NO, and the subroutine 600 advances to block 612. At block 612, the correlation search engine 214 determines that the selected candidate correlation record does not meet the expansion criterion, and returns control to its caller with this failure as a return value.

At for-loop end block 614, the subroutine 600 determines whether further variables of the selected candidate correlation record remain to be processed. If further variables remain, then the subroutine 600 returns to the for-loop start block 602 to process the next variable. Otherwise, if all of the variables have been processed, then the subroutine 600 advances from for-loop end block 614 to block 616.

By reaching block 616, the subroutine 600 has determined that the multi-variate correlation value compares favorably to all of the constituent variables within the selected candidate correlation record. Therefore, at block 616, the correlation search engine 214 determines that the selected candidate correlation record does meet the expansion criterion, and then proceeds to an end block where the subroutine 600 returns control to its caller with a success value as a return value.

It should be noted that nodes adjacent to nodes rejected by the expansion criterion of subroutine 600 are not visited from the selected candidate correlation record, but may be visited via another path through the graph. It should also be noted that while this is an example of an expansion criterion, in some embodiments, different or additional considerations may be included. For example, in some embodiments, the expansion criterion may include a minimum threshold value for the multi-variate correlation value, particularly if the graph is very large.

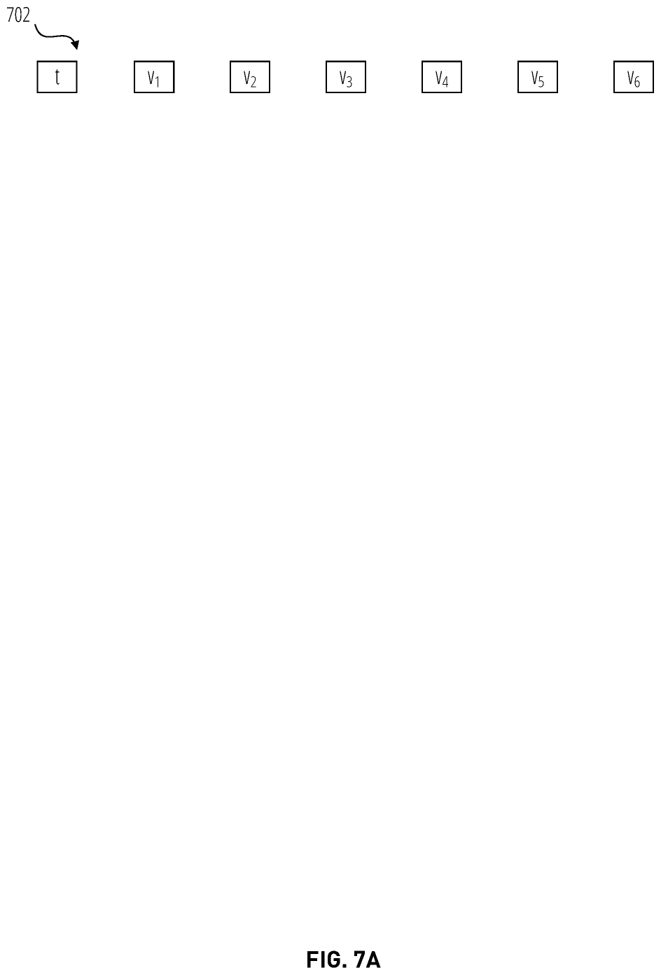

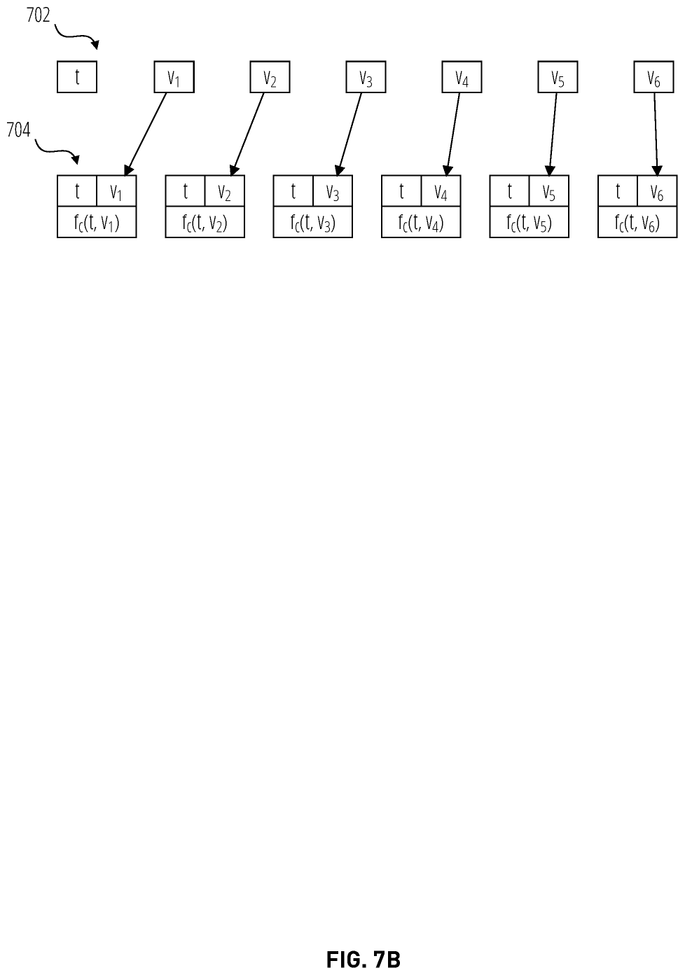

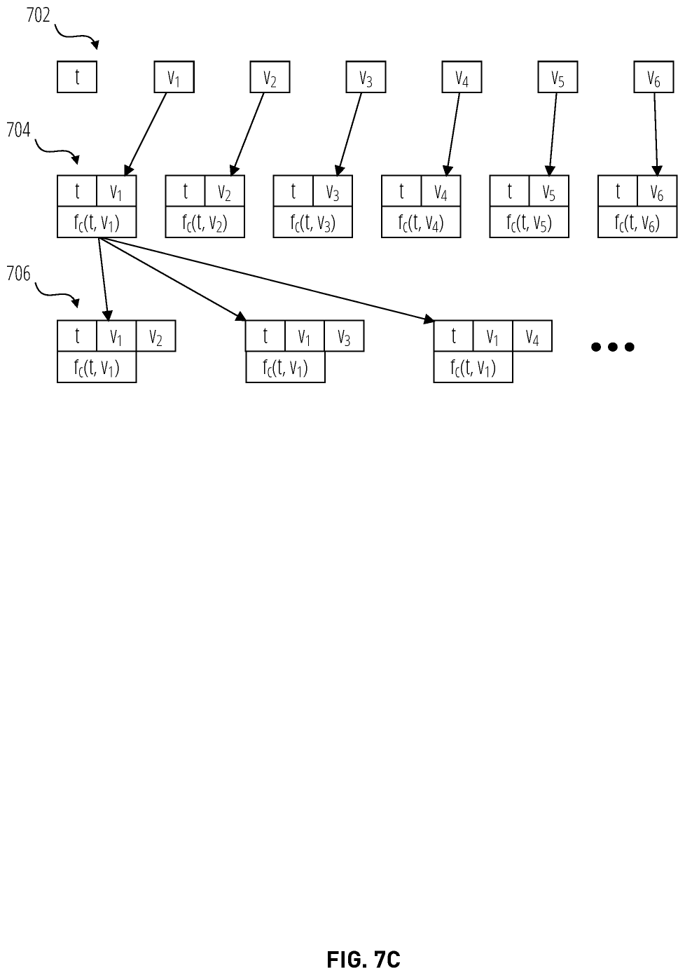

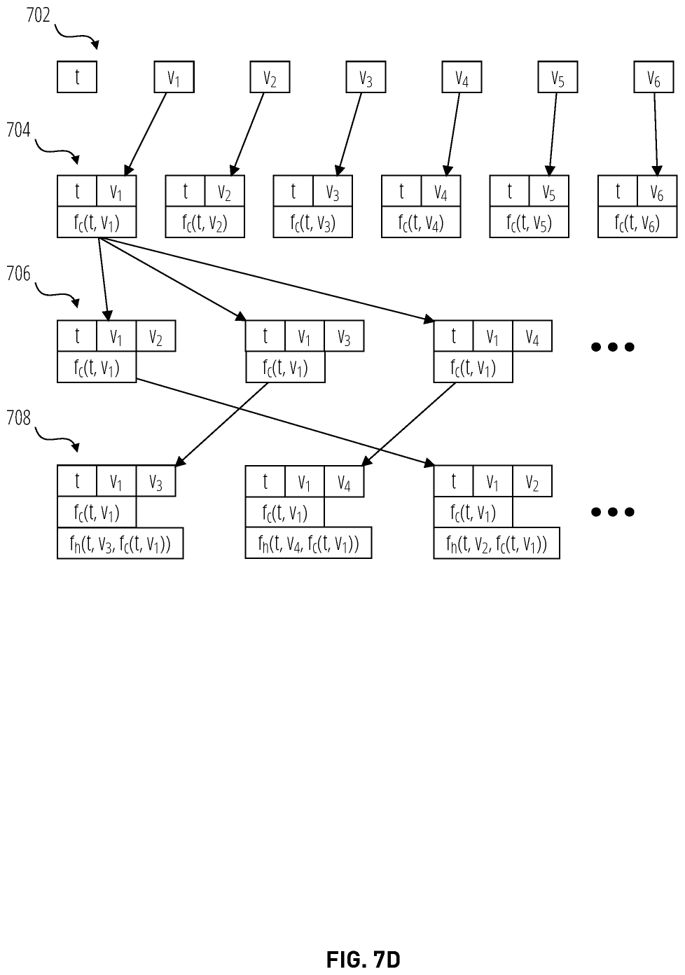

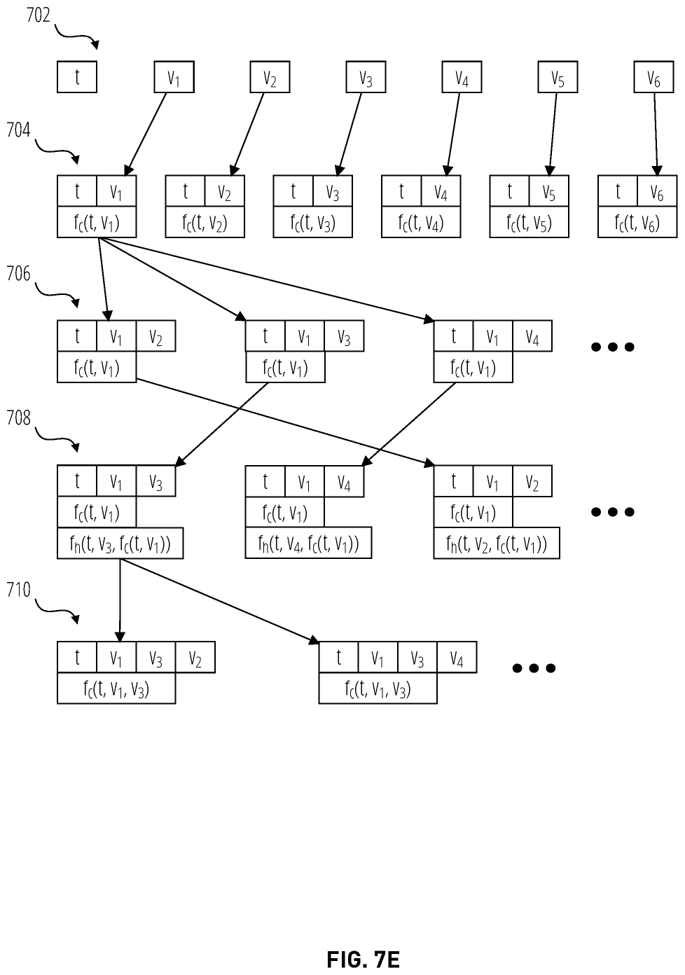

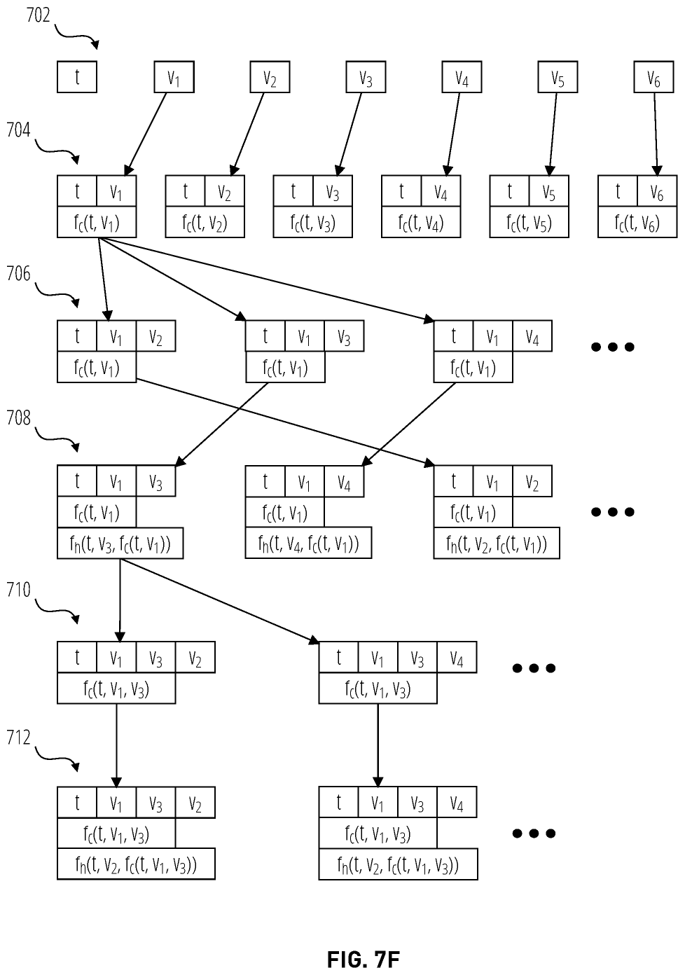

FIG. 7A-FIG. 7F are a schematic illustration of certain aspects of a non-limiting example embodiment of the graph search technique illustrated in FIG. 4A-FIG. 4B. In FIG. 7A, a set of variables 702 is illustrated including a variable of interest (t) and six other variables (v₁-v₆) to be searched for multi-variate correlations with the variable of interest.

In FIG. 7B, a visited correlation set 704 is illustrated that results from a first iteration of the beam search. In the first iteration, candidate correlation records were created for each of the pairwise correlations between the variable of interest and the other variables, and instead of determining heuristic values, the previously determined pairwise correlation values were used as the multi-variate correlation values (ƒ_{c}(t, vᵢ)) to turn each candidate correlation record into a visited correlation record in order to begin the beam search. It is assumed in FIG. 7B that the visited correlation set 704 is sorted in order of the multi-variate correlation values.

In FIG. 7C, the highest-ranking visited correlation record of the visited correlation set 704 is expanded to add candidate correlation records to a candidate correlation set 706. As shown, each candidate correlation record includes the group of variables already part of the set (t, v₁), the multi-variate correlation value for the group of variables already part of the set (ƒ_{c}(t, v₁)), and a new variable (v₂, v₃, or v₄). Candidate correlation records may also be added for the other variables, but have not been illustrated for the sake of brevity.

In FIG. 7D, an updated candidate correlation set 708 is shown, wherein heuristic values have been determined for each of the candidate correlation records, and the candidate correlation set 708 has been sorted according to the heuristic values. The heuristic values are determined based on the variable of interest, the new variable, and the multi-variate correlation value for the group of variables already part of the set.

After being sorted, the candidate correlation record for variable v₃ is considered the highest ranking candidate correlation record, and is considered to pass the expansion criterion. Accordingly, FIG. 7E shows the result of visiting and expanding this candidate correlation record. A visited correlation record is created and the multi-variate correlation value for the variable of interest, v₁, and v₃ is determined and added to the visited correlation record. The selected candidate correlation record is then removed from the candidate correlation set (not shown), and new candidate correlation records that include t, v₁, v₃, the multi-variate correlation value, and new variables are added to the candidate correlation set 710.

FIG. 7F illustrates the determination of heuristic values for the candidate correlation set 712, which again is sorted, and the process iterates again.

While illustrative embodiments have been illustrated and described, it will be appreciated that various changes can be made therein without departing from the spirit and scope of the invention.

1. A computer-implemented method of improving industrial process control by finding significant multi-variate correlations within a plurality of variables representing sensor data, the method comprising:
obtaining, by a computing system, time series data streams for the plurality of variables;
generating, by the computing system, pairwise correlation values between the variables of the plurality of variables;
determining, by the computing system, a variable of interest from the plurality of variables;
performing, by the computing system, a graph search to determine one or more significant multi-variate correlations between variables from the plurality of variables and the variable of interest, wherein variables are filtered from the graph search using a heuristic based on the pairwise correlation values; and
providing the multi-variate correlations to support the industrial process control.

2. The computer-implemented method of claim 1, wherein performing the graph search includes conducting a beam search.

3. The computer-implemented method of claim 2, wherein conducting the beam search includes:
adding, by the computing system, one or more candidate correlation records to a candidate correlation set, wherein each candidate correlation record associates the variable of interest with a second variable of the plurality of variables.

4. The computer-implemented method of claim 3, wherein conducting the beam search further includes:
calculating, by the computing device, heuristic values for each candidate correlation record in the candidate correlation set;
sorting, by the computing device, the candidate correlation records in the candidate correlation set based on the heuristic values; and
for one or more selected candidate correlation records in the sorted candidate correlation set:
generating a multi-variate correlation value between the variable of interest and other variables of the selected candidate correlation record;
generating a visited correlation record that includes the variable of interest, the other variables of the selected candidate correlation record, and the multi-variate correlation value;
adding the visited correlation record to a visited correlation set;
removing the selected candidate correlation record from the sorted candidate correlation set; and
in response to determining that the selected candidate correlation record meets an expansion criterion, expanding the candidate correlation set by:
adding one or more new candidate correlation records to the sorted candidate correlation set, wherein each of the one or more new candidate correlation records includes the variables of the selected candidate correlation record, the multi-variate correlation value, and an additional variable; and
calculating heuristic values for the one or more new candidate correlation records.

5. The computer-implemented method of claim 4, wherein the method further comprises repeating the sorting, generating, adding, removing, and selective expanding actions a predetermined number of times.

6. The computer-implemented method of claim 4, wherein calculating the heuristic values for each candidate correlation record in the candidate correlation set includes:
determining an anti-correlation value that indicates how well the new variable is anti-correlated with previous variables of the candidate correlation record; and
multiplying the anti-correlation value by at least a previously determined pairwise correlation value between the new variable and the variable of interest.

7. The computer-implemented method of claim 6, wherein determining the anti-correlation value includes:
using a previously determined pairwise correlation value between the new variable and the previous variables of the candidate correlation record that indicates a highest level of correlation to determine the anti-correlation value.

8. The computer-implemented method of claim 4, wherein generating the multi-variate correlation value includes determining at least one of a Pearson correlation or a total information criterion.

9. The computer-implemented of claim 4, wherein determining that the selected candidate correlation record meets the expansion criterion includes determining whether the multi-variate correlation value is greater than each pairwise correlation value between the variable of interest and the other variables of the selected candidate correlation record plus a constant value.

10. The computer-implemented method of claim 1, wherein providing the multi-variate correlations to support industrial process control includes presenting one or more correlation records to a user for review to support a root-cause analysis relating to the variable of interest.

11. The computer-implemented method of claim 1, wherein the industrial process control includes controlling a semiconductor manufacturing process.

12. A non-transitory computer-readable medium having computer-executable instructions stored thereon that, in response to execution by one or more processors of a computing system, cause the computing system to perform actions for improving industrial process control by finding significant multi-variate correlations within a plurality of variables representing sensor data, the actions comprising:
obtaining, by the computing system, time series data streams for the plurality of variables;
generating, by the computing system, pairwise correlation values between the variables of the plurality of variables;
determining, by the computing system, a variable of interest from the plurality of variables;
performing, by the computing system, a graph search to determine one or more significant multi-variate correlations between variables from the plurality of variables and the variable of interest, wherein variables are filtered from the graph search using a heuristic based on the pairwise correlation values; and
providing the multi-variate correlations to support the industrial process control.

13. The computer-readable medium of claim 12, wherein performing the graph search includes conducting a beam search.

14. The computer-readable medium of claim 13, wherein conducting the beam search includes:
adding, by the computing system, one or more candidate correlation records to a candidate correlation set, wherein each candidate correlation record associates the variable of interest with a second variable of the plurality of variables.

15. The computer-readable medium of claim 14, wherein conducting the beam search further includes:
calculating, by the computing device, heuristic values for each candidate correlation record in the candidate correlation set;
sorting, by the computing device, the candidate correlation records in the candidate correlation set based on the heuristic values; and
for one or more selected candidate correlation records in the sorted candidate correlation set:
generating a multi-variate correlation value between the variable of interest and other variables of the selected candidate correlation record;
generating a visited correlation record that includes the variable of interest, the other variables of the selected candidate correlation record, and the multi-variate correlation value;
adding the visited correlation record to a visited correlation set;
removing the selected candidate correlation record from the sorted candidate correlation set; and
in response to determining that the selected candidate correlation record meets an expansion criterion, expanding the candidate correlation set by:
adding one or more new candidate correlation records to the sorted candidate correlation set, wherein each of the one or more new candidate correlation records includes the variables of the selected candidate correlation record, the multi-variate correlation value, and an additional variable; and
calculating heuristic values for the one or more new candidate correlation records.

16. The computer-readable medium of claim 15, wherein the actions further comprise repeating the sorting, generating, adding, removing, and selective expanding actions a predetermined number of times.

17. The computer-readable medium of claim 15, wherein calculating the heuristic values for each candidate correlation record in the candidate correlation set includes:
determining an anti-correlation value that indicates how well the new variable is anti-correlated with previous variables of the candidate correlation record; and
multiplying the anti-correlation value by at least a previously determined pairwise correlation value between the new variable and the variable of interest.

18. The computer-readable medium of claim 17, wherein determining the anti-correlation value includes:
using a previously determined pairwise correlation value between the new variable and the previous variables of the candidate correlation record that indicates a highest level of correlation to determine the anti-correlation value.

19. The computer-readable medium of claim 15, wherein generating the multi-variate correlation value includes determining at least one of a Pearson correlation or a total information criterion.

20. The computer-readable medium of claim 15, wherein determining that the selected candidate correlation record meets the expansion criterion includes determining whether the multi-variate correlation value is greater than each pairwise correlation value between the variable of interest and the other variables of the selected candidate correlation record plus a constant value.
